(19) United States
(12) Patent Application Publication
(10) Pub. No.: US 2009/0009484 A1
(43) Pub. Date: Jan. 8, 2009

(54) Touch-detection display device having a detection and control unit and method to drive same

(75) Inventors: Chuan-Pei Yu, Miao-Li (TW); Yen-Hua Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/217,341

(22) Filed: Jul. 3, 2008

(30) Foreign Application Priority Data
Jul. 4, 2007 (CN) 200710076381.1

(51) Int. Cl. G06F 3/041; G09G 3/36

(52) U.S. Cl. 345/173; 345/102

(57) ABSTRACT

An exemplary touch-detection display device includes a display unit configured to display images, a touch-detection unit configured to detect external contact thereon, and a control and detection unit configured to detect functional conditions of the display unit and switch the touch-detection unit according to the functional conditions of the display unit. A related method of driving the touch-detection display device is also provided.

### FIELD OF THE INVENTION

The present invention relates to a touch-detection display device having a detection and control unit, and a method to drive the touch-detection display device.

### BACKGROUND

Currently, resistive, static-capacitive, and pressure-sensitive touch panels are widely used in different electronic devices, particularly mobile electronic devices. Liquid crystal displays (LCDs) combined with touch panels have become more and more popular in business and entertainment.

FIG. 4 shows a conventional touch-detection display device 1, deployable in mobile electronic devices, includes a display unit 16 and a touch-detection unit 10. The display unit 16 comprises an LCD panel 17 and a backlight module 18 providing backlight for the LCD panel 17. The touch-detection unit 10 further includes a touch panel 11, an analog to digital (A/D) converter 12, a processor 13, and a touch panel driver 14.

The touch panel driver 14 is configured to drive the touch panel 11. The touch panel 11 is configured to detect external touch actions, and generate analog touch signals corresponding to. The analog touch signals are converted to digital touch signals by the A/D converter 12. The processor 13 receives and processes the digital touch signals and outputs corresponding control signals to the LCD panel 17. The LCD panel 17 displays corresponding images accordingly.

Generally, batteries provide power for the majority of mobile electronic devices, such as cell phones, personal digital assistants (PDAs), and the like. Despite power stored in a battery being limited, touch-detection unit 10 consumes considerable power to function. Even when in a standby state, the touch-detection unit 10 continues to consume electrical power. Such increased power consumption of the touch-detection display device 1 restricts the service time thereof. Further, when in a standby condition, the touch-detection unit 10 remains susceptible to unwanted registration of unintentional contact. Reliability of the touch-detection display device 1 is thus limited.

Accordingly, what is needed is a touch-detection display device and a method of driving the same which can overcome the limitations described.

### SUMMARY

A touch-detection display device includes a display unit configured to display images, a touch-detection unit configured to detect external contact applied thereto, and a control and detection unit configured to detect functional conditions of the display unit and switch the touch-detection unit according to a result of the detection.

A method of driving a touch-detection display device is also provided. The touch-detection display device includes a display unit, a touch-detection unit, and a control and detection unit. The method comprises the control and detection unit detecting a current functional condition of the display unit and switching the touch-detection unit accordingly.

Other novel features and advantages will become more apparent from the following detailed description when taken in conjunction with the accompanying drawings.

### BRIEF DESCRIPTION OF THE DRAWINGS

FIG. 1 is a block diagram of a touch-detection display device according to a first embodiment of the present invention.

FIG. 2 is a flowchart of an exemplary method of driving the touch-detection display device of FIG. 1.

FIG. 3 is a block diagram of a touch-detection display device according to a second embodiment of the present invention.

FIG. 4 is a block diagram of a conventional touch-detection display device.

### DETAILED DESCRIPTION OF PREFERRED EMBODIMENTS

FIG. 1 is a block diagram of a touch-detection display device according to a first embodiment of the present invention. The touch-detection display device 2, deployable, for example, in mobile electronic devices, comprises a display unit 22, a touch-detection unit 21, and a detection and control unit 23.

The display unit 22 comprises an LCD panel 221 configured to display images, and a backlight module 222 configured to provide backlight for the LCD panel 221.

The touch-detection unit 21 comprises a touch panel 211, an A/D converter 212, a processor 213, and a touch panel driver 214. The touch panel driver 214 is configured to drive the touch panel 211. The touch panel 211 is configured to detect external contact and generate analog touch signals correspondingly. The analog touch signals are converted to digital touch signals by the A/D converter 212. The processor 213 receives and processes the digital touch signals, and then outputs corresponding control signals to the LCD panel 221. The LCD panel 221 generates a corresponding display according to the control signals.

The detection and control unit 23 comprises a controller 231, a light sensor 232, and a memory 233. The memory 223 is typically a non-volatile random access memory (NVRAM). The memory 223 stores relationships between functional conditions of the display unit 22 and brightness changes in the environment. The functional conditions can, for example, include a working state and a standby state. The light sensor 232 is configured to detect environmental brightness according to preset detection parameters, and convert the environmental brightness to an electronic brightness signal. The controller 231 is configured to receive the electronic brightness signal, calculate brightness change in the environment, compare brightness changes in the environment with information stored in the memory 233, and output driving signals to switch the touch panel driver 214 accordingly, controlling the touch-detection unit 21 for use.

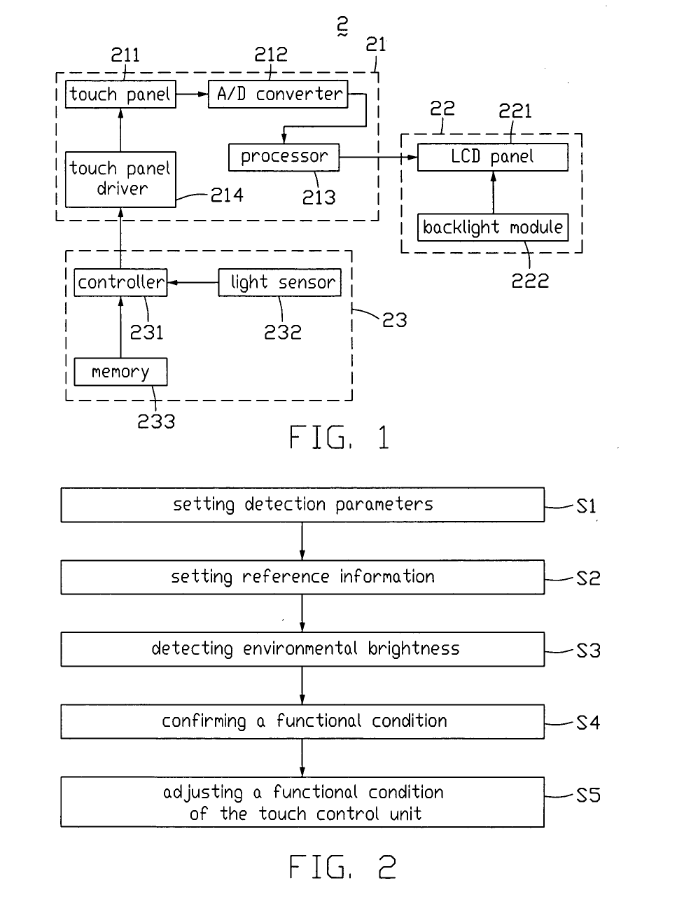

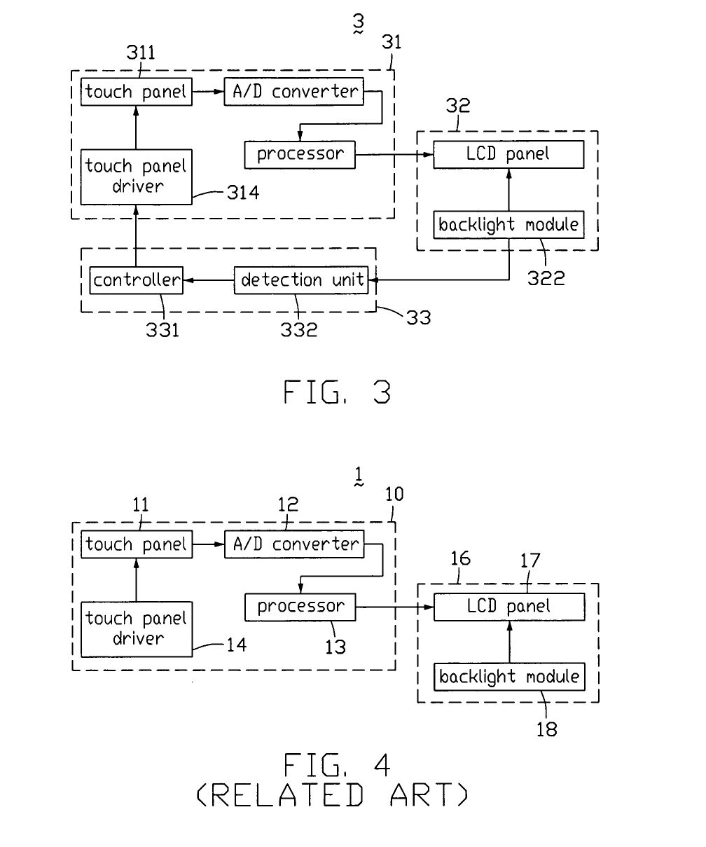

FIG. 2 is a flowchart of an exemplary method of driving the touch-detection display device 2. The method includes: step S1, setting detection parameters; step S2, setting reference information; step S3, detecting environmental brightness; step S4, confirming a functional condition, and; step S5, adjusting a functional condition of the touch control unit. The detailed method is described as follows.

In step S1, detection parameters of the light sensor 232 for detecting environmental brightness are set. The detection parameters can, for example, include detection frequency, detection duration each time detection is performed, sensitivity of the light sensor 232, and the like.

In step S2, relationships between the functional conditions and brightness changes in the environment are set. The brightness changes can, for example, include brightness change frequency, brightness change ratio, and the like.

In step S3, the light sensor 232 is activated and detects the environmental brightness according to the detection parameters. During detection, the light sensor 232 converts the environmental brightness signal(s) into corresponding electronic brightness signals and sends the electronic brightness signals to the controller 231.

In step S4, when the controller 231 receives the electronic brightness signals from the light sensor 232, the controller 231 processes the electronic brightness signals to confirm the state of the environment brightness. Controller 231 then refers to the memory 233 to locate a functional condition corresponding to the environment brightness. Thus, the controller can recognize whether the touch-detection display device 2 is in use or in a standby state. Controller 231 then generates a control signal to the touch panel driver 214, to switch the touch panel 211. For example, when the touch-detection display device 2 is situated for use, the environmental brightness changes, light sensor 232 detects the corresponding brightness change in the environment, and controller 231 confirms that the touch-detection display device 2 is in use according to the information stored in the memory 233. Controller 231 sends a switch-on signal to the touch panel driver 214, activating touch-detection unit 21. When the touch-detection display device 2, not in use, is laid down or stowed, environmental brightness changes are stabilized. Commensurately, the controller 231 receives the signal representing steady environmental brightness, and confirms that the touch-detection display device 2 is in a standby state according to the information stored in the memory 233. Controller 231 sends a switch-off signal to the touch panel driver 214 to shut down the touch-detection unit 21.

In step S5, when the touch panel driver 214 receives a switch-on signal from the controller 231, the touch panel driver 214 powers up, and the touch-detection unit 21 is activated for use. Control signals can be input through the touch-detection unit 21 to the display unit 22. When the touch panel driver 214 receives a switch-off signal from the controller 231, the touch panel driver 214 stops, and the touch-detection unit 21 is deactivated. The touch-detection unit 21 is disabled and unresponsive to external contact.

In the disclosed touch-detection display device 2, the detection and control unit 23 is configured to detect brightness changes in the environment, thereby confirming the functional condition of the touch-detection display device 2. Accordingly, only when the touch-detection display device 2 is in a normal functional state can the touch-detection unit 21 be activated. When the touch-detection display device 2 is in the standby state, the touch-detection unit is deactivated. This not only reduces total power consumption of the touch-detection display device 2, but also prevents registration of erroneous contact to the touch-detection display device 2.

FIG. 3 is a block diagram of a touch-detection display device according to a second embodiment of the present invention. The touch-detection display device 3 has a structure similar to the touch-detection display device 2. However, the detection and control unit 33 comprises a controller 331 and a detection unit 332. The detection unit 332 is configured to detect a functional condition of the display unit 32 and transmit corresponding signals to the controller 331. Detailed operation of the touch-detection display device 3 is described as follows.

In this embodiment, the detection unit 332 detects a light intensity or an electric current density of the backlight module 322, and sends the light intensity signal or the electric current density signal to the controller 331. When the light intensity or electric current density exceeds a corresponding predetermined threshold, the controller 331 confirms that the display unit 32 is in a functional state. The controller 331 then sends a switch-on signal to the touch panel driver 314, which powers up accordingly. Thus, the touch panel driver 314 enables and drives the touch panel 311 to be able to detect any external contact thereto. Accordingly, the touch-detection unit 31 is activated for use. A light intensity or electric current density falling below the corresponding threshold is detected and sent to the controller by the detection unit 322, at which time the controller 331 confirms that the display unit 32 is in a standby state. Then the controller 331 sends a switch-off signal to the touch panel driver 314, thereby switching off the touch panel driver 314. Touch panel 311 ceases to detect any external contact thereto and the touch-detection unit 31 is deactivated, with the touch-detection display device 3 fully in a power-saving mode.

As described, the detection and control unit 33 detects internal parameters of the display unit 32, such as the light intensity of the backlight, the electric current density thereof, and the like, to confirm the functional condition of the touch-detection display device 3, and thereupon sends appropriate control signals to control the touch-detection unit 31. Thus, the touch-detection display device 3 is able to automatically switch the touch control unit 31 between functional use or power-saving mode according to the functional condition of the display unit 32. Accordingly, the touch-detection display device 3 consumes less power and has improved reliability.

It is to be understood that even though numerous characteristics and advantages of the present embodiments have been set out in the foregoing description, together with details of the structures and functions of the embodiments, the disclosure is illustrative only; and that changes may be made in detail, especially in matters of shape, size, and arrangement of parts within the principles of the invention to the full extent indicated by the broad general meaning of the terms in which the appended claims are expressed.

What is claimed is:

1. A touch-detection display device, comprising:
a display unit configured to display images;
a touch-detection unit configured to detect external contact applied thereto; and
a control and detection unit configured to detect predetermined functional conditions of the display unit and switch the touch-detection unit according to a result of the detection.

2. The touch-detection display device of claim 1, wherein the control and detection unit comprises a memory, a light sensor, and a controller, the memory storing reference information, the light sensor detecting environmental brightness and transmitting electronic signals to the controller accordingly, and the processor processing the electronic signals and switching the touch-detection unit according to the stored reference information.

3. The touch-detection display device of claim 1, wherein the memory is a non-volatile random access memory.

4. The touch-detection display device of claim 1, wherein the touch-detection unit comprises a touch panel and a touch panel driver, wherein the touch panel driver drives the touch panel according to control signals from the control and detection unit.

5. The touch-detection display device of claim 1, wherein the display unit comprises a liquid crystal display panel and a backlight module providing backlight for the liquid crystal display panel.

6. The touch-detection display device of claim 5, wherein the control and detection unit comprises a controller and a detection unit, wherein the detection unit detects internal parameters of the display unit and the controller processes the internal parameters received from the detection unit to confirm the current functional condition of the display unit and switches the touch-detection unit accordingly.

7. The touch-detection display device of claim 6, wherein the internal parameters comprise at least one of a light intensity of the backlight and an electrical current density of the backlight module.

8. The touch-detection display device of claim 7, wherein when the light intensity is below a predetermined light intensity threshold, the control and detection unit switches off the touch-detection unit.

9. The touch-detection display device of claim 7, wherein when the current density is below a predetermined current density threshold, the control and detection unit switches on the touch-detection unit.

10. The touch-detection display device of claim 1, wherein when the display unit is in a standby state, the control and detection unit deactivates the touch-detection unit.

11. A method of driving a touch-detection display device, the touch-detection display device comprising a display unit, a touch-detection unit, and a control and detection unit, the method comprising:
determining a current functional condition of the display unit by the control and detection unit; and
switching the touch-detection unit according to the current functional condition of the display unit.

12. The method of claim 11, wherein when the display unit is in a standby state, the control and detection unit switches on the touch-detection unit.

13. The method of claim 11, wherein the control and detection unit comprises a memory, a light sensor, and a controller, the memory storing reference information, the light sensor detecting environmental brightness and transmitting electronic signals to the controller accordingly, and the processor processing the electronic environmental brightness signal and switching the touch-detection unit according to the reference information stored in the memory.

14. The method of claim 13, further comprising setting detection parameters of the light sensor, setting reference information to the memory, the light sensor detecting environmental brightness, the controller calculating brightness changes in the environment according to the detected brightness signals from the light sensor, comparing the calculation result to the reference information stored in the memory and confirming a current functional condition of the display unit, and switching the touch-detection unit according to the confirmed current functional condition of the display unit.

15. The method of claim 11, wherein the display unit comprises a liquid crystal display panel and a backlight module providing backlight for the liquid crystal display panel.

16. The method of claim 15, wherein the control and detection unit comprises a controller and a detection unit, wherein the detection unit detects internal parameters of the display unit, and the controller processes the internal parameters received from the detection unit to confirm a current functional condition of the display unit and switches the touch-detection unit according to the confirmed functional condition of the display unit.

17. The method of claim 16, wherein the internal parameters comprise at least one of a light intensity of the backlight and an electrical current density of the backlight module.

18. The method of claim 17, when the light intensity is below a predetermined light intensity threshold, the control and detection unit switches off the touch-detection unit.

19. The method of claim 17, wherein when the current density is below a predetermined current density threshold, the control and detection unit activates the touch-detection unit.
